(19) United States
(12) Patent Application Publication
(10) Pub. No.: US 2026/0140670 A1
(43) Pub. Date: May 21, 2026

(54) STORAGE MEDIUM STORING APPLICATION PROGRAM, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: KIMIMORI EGUCHI, Chiba (JP)

(21) Appl. No.: 19/382,863

(22) Filed: Nov. 7, 2025

(30) Foreign Application Priority Data
Nov. 19, 2024 (JP) 2024-201697

(51) Int. Cl. G06F 3/12

(52) U.S. Cl. CPC G06F 3/1205; G06F 3/1228; G06F 3/1253

(57) ABSTRACT

A mechanism capable of performing a thickness adjustment setting for adjusting thickness of a line constituting an image to be printed by executing an application program supporting a standard driver provided from a provider of an operating system of an information processing apparatus. A non-transitory computer-readable storage medium storing an application program causing a computer of the information processing apparatus to execute a control method including supporting the standard driver, causing a display to display a setting reception screen on which a setting of a thickness adjustment to adjust a thickness of a line constituting an image to be printed is accepted, and instructing an image forming apparatus to execute printing based on the setting of the thickness adjustment accepted on the setting reception screen.

### BACKGROUND

### Field of the Technology

The aspect of the embodiments relates to a storage medium storing an application program, a control method for an information processing apparatus, and the information processing apparatus.

### Description of the Related Art

A host computer (an information processing apparatus) capable of processing information with a printing apparatus is communicably connected to the printing apparatus. As control software to control the printing apparatus, for example, a printer driver installed in the host computer from the printing apparatus is used. The printer driver enables the host computer to issue a print instruction to the printing apparatus. An operating system (hereinafter referred to as an “OS”), which is basic software, is installed in the host computer in advance. The printer driver has a configuration in accordance with the specification defined by the OS, and can be called from the OS to operate. In addition, such a printer driver is different for each vendor that supplies the printing apparatus, that is, a printer driver specific to a model suitable for each printing apparatus.

In recent years, Windows (registered trademark) provides a standard class driver (hereinafter, may be referred to as a “standard driver”) that can be commonly used even in printing apparatuses supplied by a plurality of different vendors. Such a standard driver is incorporated in the OS in advance. The standard driver can be used by connecting an arbitrary printing apparatus to a host computer having the OS in which the standard driver is incorporated. This is able to omit installation of the printer driver unique and suitable to the model. The standard driver can designate and use a print function in the printing apparatus in accordance with Print Device Capabilities (hereinafter referred to as “PDC”) generated on the basis of information obtained from the printing apparatus. This enables one standard driver to designate a print function for each printing apparatus. A function expansion application (hereinafter, may be referred to as an “expansion application”) for expanding a function can be associated with the standard driver. The expansion application is provided by each vendor. Therefore, it is difficult to execute the function of the expansion application by the standard driver alone.

Japanese Patent Laid-Open No. 2020-166363 (JP-A-2020-166363) discloses an expansion application that causes a standard driver to generate data for causing a printing apparatus to print a substitute image that substitutes for an image of a barcode when an information indicating a barcode is included in an image data to be printed.

As described above, the printer driver is different for each vendor that supplies a printing apparatus, that is, the printer driver is a model-specific printer driver suitable for each printing apparatus. The printer driver can cause the printing apparatus to perform printing in which thickness of a linear portion (line weight) such as a character or a ruled line constituting an image to be printed is adjusted (changed). This enables adjustment of thickness of a frame of a barcode image, for example. On the other hand, the standard driver has a problem that it is not possible to instruct a printing apparatus to perform printing with thickness of a linear portion adjusted.

### SUMMARY

The present disclosure provides a mechanism capable of performing a thickness adjustment setting for adjusting thickness of a line constituting an image to be printed by executing an application program supporting a standard driver provided from a provider of an operating system of an information processing apparatus.

Accordingly, an aspect of the embodiments provides a non-transitory computer-readable storage medium storing an application program causing a computer of an information processing apparatus to execute a control method including supporting a standard driver provided from a provider of an operating system of the information processing apparatus, causing a display to display a setting reception screen on which a setting of a thickness adjustment to adjust a thickness of a line constituting an image to be printed is accepted, and instructing an image forming apparatus to execute printing based on the setting of the thickness adjustment accepted on the setting reception screen.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a print system according to a first embodiment.

FIG. 2A and FIG. 2B are block diagrams showing software configurations of the print system.

FIG. 3A to FIG. 3D are views illustrating examples of print setting screens displayed on a display unit of the print system.

FIG. 4 is a flowchart illustrating a thickness adjustment process.

FIG. 5A to FIG. 5J are image diagrams indicating an outline of the thickness adjustment process.

FIG. 6 is a flowchart illustrating a process in which a print function expansion unit edits print function information.

FIG. 7 is a view illustrating an example of a list of capability information of a printing apparatus.

FIG. 8 is a view illustrating an example of a list of print functions supported by an expansion application.

FIG. 9 is a view illustrating an example of a list of capability information about general-purpose print software.

FIG. 10 is a sequence chart illustrating a process executed among a drawing application, a general-purpose print software, the expansion application, and the printing apparatus after the drawing application accepts a print setting.

FIG. 11 is a block diagram illustrating a software configuration of a print system according to a second embodiment.

FIG. 12 is a flowchart illustrating a process in which the print function expansion unit edits the print function information.

FIG. 13 is a sequence chart illustrating a process executed among the drawing application, the general-purpose print software, the expansion application, and the printing apparatus after the drawing application accepts a print setting.

FIG. 14 is a flowchart illustrating a process in which the print function expansion unit related to a third embodiment edits the print function information.

FIG. 15 is a view illustrating an example of a list of capability information of the printing apparatus.

FIG. 16 is a view illustrating an example of a list of print functions supported by the expansion application.

FIG. 17 is a view illustrating an example of a screen displayed on the display unit of the print system.

FIG. 18A is a view illustrating an example of a screen displayed on the display unit of the print system.

FIG. 18B is a view illustrating an example of a screen displayed on the display unit of the print system.

FIG. 19 is a sequence chart illustrating a process executed among the drawing application, the general-purpose print software, the expansion application, and the printing apparatus after the drawing application accepts a print setting.

### DESCRIPTION OF THE EMBODIMENTS

Hereinafter, embodiments of the present disclosure will be described in detail with reference to the drawings. However, configurations described in the following embodiments are merely examples, and the scope of the present disclosure is not limited by the configurations described in the embodiments. For example, each unit constituting the present disclosure can be replaced with any configuration capable of exhibiting the same function. In addition, an arbitrary constituent may be added. Any two or more configurations (features) of the embodiments can be combined.

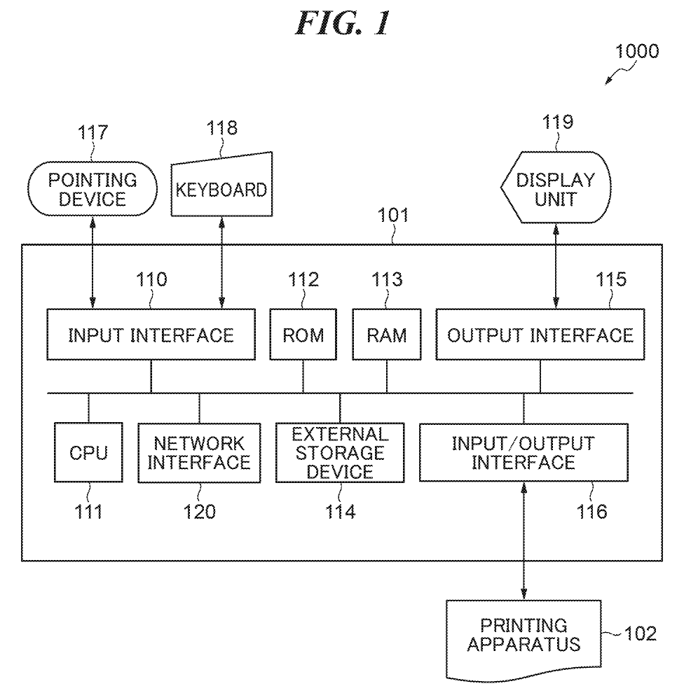

Hereinafter, a first embodiment will be described with reference to FIG. 1 to FIG. 10. FIG. 1 is a block diagram illustrating a hardware configuration of a print system according to the first embodiment. As illustrated in FIG. 1, the print system 1000 includes a host computer 101, a printing apparatus 102, a pointing device 117, a keyboard 118, and a display unit 119, which are communicably connected to each other. The host computer 101 is an information processing apparatus and has an input interface 110, a CPU 111, a ROM 112, a RAM 113, an external storage device (storage medium) 114, an output interface 115, an input/output interface 116, and a network interface 120. The host computer 101 is, for example, a desktop personal computer, a notebook personal computer, a tablet terminal, a smartphone, or the like.

The CPU 111 is a computer that executes a program stored in the ROM 112 or the external storage device 114. This enables the CPU 111 to execute steps (a control method) described later. The ROM 112 stores an initialization program. The external storage device 114 stores an application program group, an operating system (OS), print data generation software, and other various data. In this embodiment, Windows (registered trademark) 11 of Microsoft (registered trademark) is installed in the host computer 101 as the OS. The RAM 113 is used as a work memory when executing various programs stored in the external storage device 114 so that the various programs can operate in the host computer 101.

The input interface 110 is connected to the pointing device 117 and the keyboard 118 as input devices. The output interface 115 is connected to the display unit 119 as a display device. For example, a print setting screen 300A, an advanced setting screen 300C, which will be described later, are displayed on the display unit 119. The network interface 120 controls data transfer with an external apparatus via the network. The printing apparatus 102 is connected to the input/output interface 116. The host computer 101 can communicate with the printing apparatus 102 regardless of a manufacturer of the printing apparatus 102, that is, can process information with printing apparatuses of manufacturers.

As the printing apparatus 102, for example, an image forming apparatus such as a multi-function peripheral (MFP) having a plurality of functions, such as copying, printing, and facsimile, can be used, but the printing apparatus is not limited thereto. In addition, the printing apparatus 102 employs an electrophotographic system in this embodiment, but this is not limiting, and may employ an inkjet system, for example. Although the host computer 101 and the printing apparatus 102 are configured as separate devices in the present embodiment, this is not limited. For example, the host computer 101 and the printing apparatus 102 may be configured as an integrated apparatus.

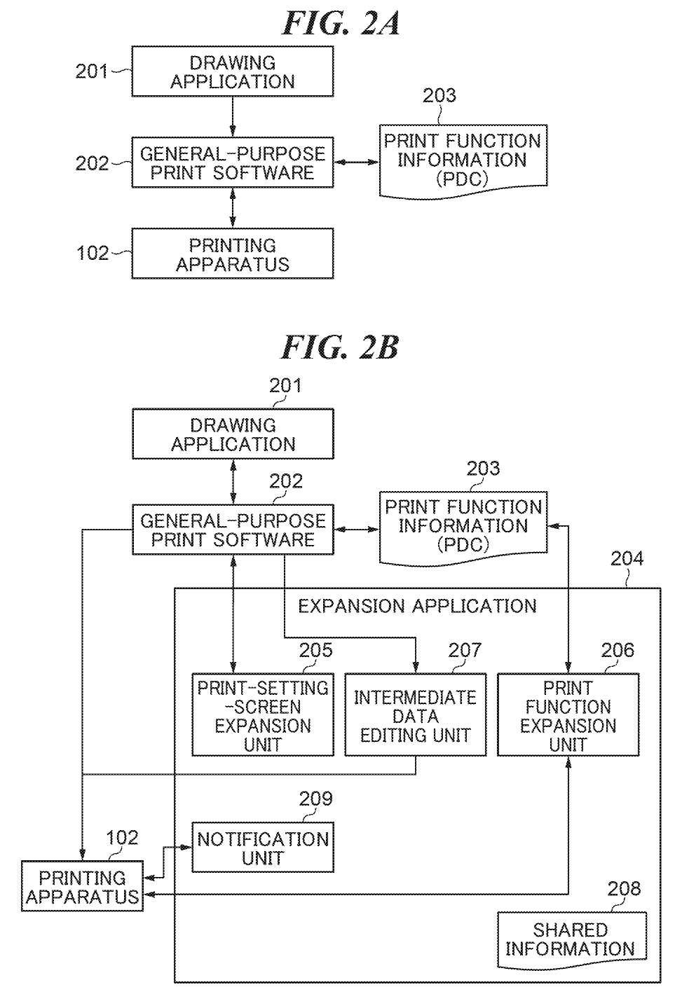

FIG. 2A and FIG. 2B are block diagrams showing software configurations of the print system. FIG. 2A is the diagram illustrating a general configuration in a case where an expansion application (application program) 204 is not associated with a general-purpose print software (standard driver) 202 and the printing apparatus 102. FIG. 2B shows the configuration in which the expansion application 204 is associated with the general-purpose print software 202 and the printing apparatus 102.

The general-purpose print software 202 is a standard driver provided by the provider of the OS. The standard driver is a class driver (general-purpose program) that can be used in common, for example, at the time of printing, for printing apparatuses (printing apparatus 102) of a plurality of manufacturers. The standard driver is installed (incorporated) in the OS in advance, that is, provided as one of functions in a package of the OS. The standard driver can perform processes for various printing apparatuses by using a standardized printing method. This enables the standard driver to generate and output instructions that can be interpreted by printing apparatuses of a plurality of manufacturers.

The general-purpose print software 202 is a program that operates based on the IPP (Internet Printing Protocol). The expansion application 204 is a program that supports, i.e., supplements, the general-purpose print software 202. Although the expansion application 204 is an expanded program (a program that executes a control method) that is capable of expanding a function that is not executable on the printing apparatus 102 by the general-purpose print software 202 in the present embodiment, this is not limited. For example, the expansion application 204 may improve convenience of a function that is executable by the general-purpose print software 202 with respect to the printing apparatus 102. The expansion application 204 is stored in the external storage device 114 together with the OS including the general-purpose print software 202, for example. Accordingly, the host computer 101 includes the general-purpose print software 202 and the expansion application 204.

First, the configuration in which the expansion application 204 is not associated with the general-purpose print software 202 and the printing apparatus 102 will be described with reference to FIG. 2A. A drawing application 201 is software to generate a content (print data) to be printed by the printing apparatus 102. The drawing application 201 is not particularly limited, and may be, for example, a document generation application or a spreadsheet application. The drawing application 201 issues a print instruction to the OS upon receiving a print request from a user via the keyboard 118, for example. The print instruction includes print setting information for instructing operations of the general-purpose print software 202 and the printing apparatus 102. The print setting information is also referred to as a “Print Ticket (PT)”.

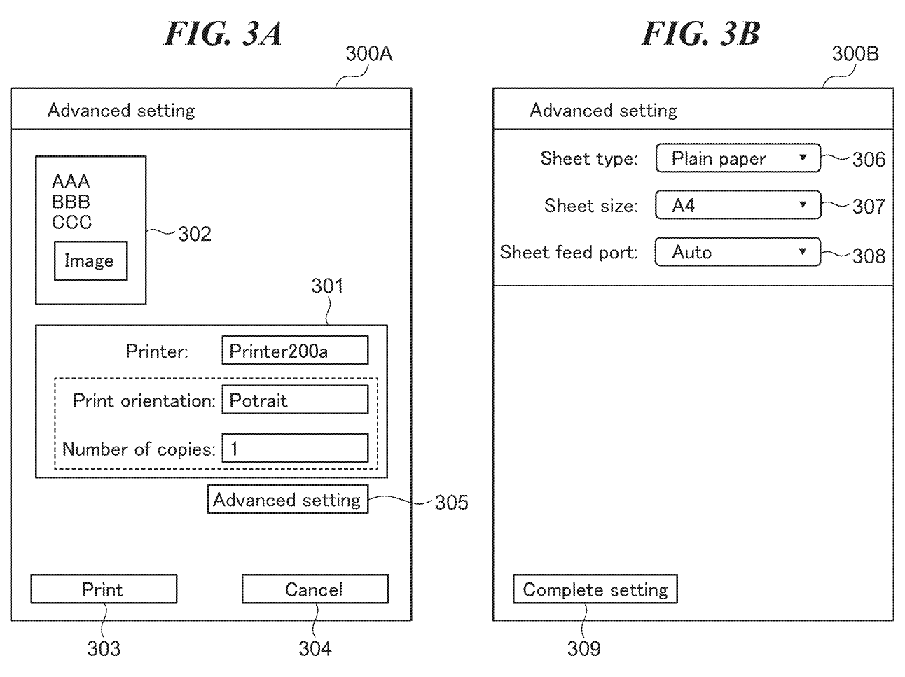

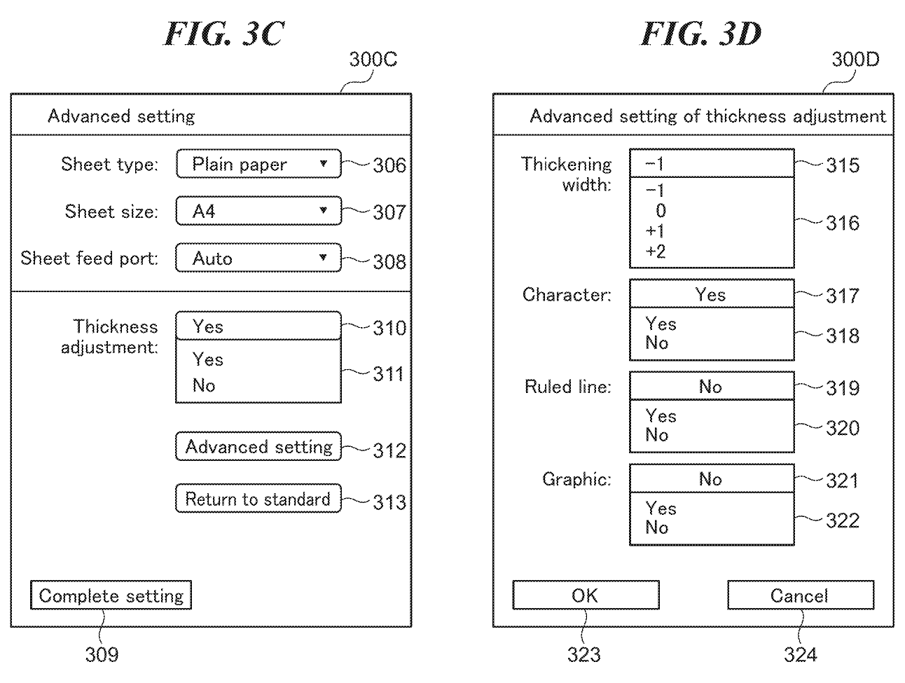

In addition, the drawing application 201 can display the print setting screen 300A (see FIG. 3A) provided by any one of the general-purpose print software 202, the OS, and the drawing application 201 on the display unit 119 in order to output the print setting information. In addition, when a user operates (presses) a control 305 in the print setting screen 300A, an advanced setting screen 300B (see FIG. 3B) or the advanced setting screen 300C (see FIG. 3C) can be displayed on the display unit 119. The print setting screen 300A and the advanced setting screens 300B and 300C will be described later.

On the print setting screen 300A, setting items indicating settable print functions and control items indicating set values thereof are displayed in accordance with capability information obtained from the general-purpose print software 202, that is, information settable as print settings. The capability information shows the capability of the printing apparatus 102 to perform printing, and is also referred to as Print Capabilities (hereinafter, may be referred to as “PC”). It is also possible to determine whether the capability information includes information that enables to display the advanced setting screen 300C, that is, information that enables execution of printing based on a thickness adjustment setting (a determination step). Then, as a result of this determination, when it is determined that the information that enables to display the advanced setting screen 300C is included, the advanced setting screen 300C can be displayed. On the other hand, when it is determined that the information that enables to display the advanced setting screen 300C is not included, the advanced setting screen 300C is not displayed. In this manner, the expansion application 204 can switch whether to display the advanced setting screen 300C according to the capability information of the printing apparatus 102.

In addition, when the advanced setting screen 300C is displayed, it is possible to instruct to execute printing based on the thickness adjustment setting received on the advanced setting screen 300C to the printing apparatus 102. On the other hand, when the advanced setting screen 300C is not displayed, normal print data, that is, print data in which the thickness adjustment is not reflected is generated, and it is possible to instruct to print the print data to the printing apparatus 102.

The general-purpose print software 202 decides the PC based on the print function information 203. The print function information 203 is data indicating all settable print functions, set values thereof, and exclusive relationship between the set values. The print function information 203 is also called PDC (Print Device Capabilities). The print function information 203 is included in configuration files of the general-purpose print software 202 and is arranged in the external storage device 114 as an unchangeable file.

Alternatively, the print function information 203 may be dynamically generated by the general-purpose print software 202. Specifically, the general-purpose print software 202 obtains attribute data of the printing apparatus 102 from the printing apparatus 102. The general-purpose print software 202 generates the print function information 203 based on attribute information in the attribute data. When the print function information 203 is dynamically generated in this manner, the print function information 203 can be edited. The attribute data of the printing apparatus 102 is a response obtained by issuing a Get-Printer-Attributes operation of the IPP to the printing apparatus 102. The response includes the attribute information indicating functions that can be designated in the printing apparatus 102, that is, the capability of the printing apparatus 102, and set values related to the attribute information. The response is stored in the RAM 113.

With this configuration, the general-purpose print software 202 can be configured so that the user can designate print functions available in the printing apparatus 102 in accordance with the printing apparatus 102 connected to the general-purpose print software 202. This enables to designate a print function available in a printing apparatus regardless of a model of the printing apparatus connected to the general-purpose print software 202, that is, even when a printing apparatus having a different function or a printing apparatus developed by a different printer manufacturer is connected.

In the present embodiment, the general-purpose print software 202 shall use an “IPP Class Driver” installed in Windows (registered trademark) 11. The “IPP Class Driver” executes a print process in accordance with the specification of the standard print protocol called the IPP, and is included in the package of the OS. The “IPP Class Driver” is not a unique printer driver corresponding to the model of the printing apparatus 102, but is a standard class driver that can be commonly used in printing apparatuses of printer manufacturers regardless of a printer manufacturer. The “IPP Class Driver” obtains the capability information about the printing apparatus 102 and generates the print function information 203 based on the capability information.

Also, the general-purpose print software 202 may be associated with the expansion application 204. This enables the general-purpose print software 202 to execute a function that is not included in the general-purpose print software 202. For example, the IPP Class Driver (the general-purpose print software 202) cannot execute a function of receiving a setting for adjusting thickness of lines such as characters and ruled lines constituting an image to be printed (hereinafter referred to as a “thickness adjustment setting”). This is because a thickness adjustment setting function is a unique function executed by a printing apparatus manufactured by a predetermined printer manufacturer. The expansion application 204 can expand the function of the general-purpose print software 202 so as to execute the thickness adjustment setting function that cannot be executed by the IPP Class Driver.

In the present embodiment, the IPP Class Driver cannot execute the thickness adjustment setting function and the expansion application 204 can expand the function of the general-purpose print software 202 so as to execute the thickness adjustment setting function, but this is not limited. For example, the IPP Class Driver may execute a part of the thickness adjustment setting function, and the expansion application 204 may compensate for the shortage of the thickness adjustment setting function to further expand an execution range.

The OS generates intermediate data (may be referred to as “input data”) based on the print instruction output from the drawing application 201, and transmits the intermediate data to the general-purpose print software 202. A format of the data output for printing by the drawing application 201 is not particularly limited, and is preferably, for example, an XML Paper Specification format (XPS format). The data output for printing by the drawing application 201 may be a data in a Graphic Device Interface format (GDI format). In a case where the IPP Class Driver is used as the general-purpose print software 202, if the data output by the drawing application 201 is GDI format data, the OS converts the GDI format data into XPS format data. Then, the OS transmits the converted XPS format data to the general-purpose print software 202 as the intermediate data. In addition, when the data output by the drawing application 201 is data in the XPS format, the OS transmits the data in the XPS format to the general-purpose print software 202 as the intermediate data. The intermediate data includes drawing data that is information about characters and figures to be formed on a print medium and print setting information set by a user.

The general-purpose print software 202 converts the intermediate data into printable data (image data) that can be processed by the printing apparatus 102, and transmits the print data to the printing apparatus 102. Here, the “print data” in this embodiment is Page Description Language (PDL) data conforming to the IPP. The PDL data is, for example, data in a PDF (Portable Document Format) or a PWG-Raster format. The print data includes drawing data that is information about characters and figures to be formed on a print sheet (print medium), and print setting attribute information that is generated based on the print setting information set by the user and designates the print setting. The print setting attribute information includes attribute information indicating functions that can be designated in the printing apparatus 102, that is, capabilities of the printing apparatus 102, and set values associated with the attribute information.

The printing apparatus 102 performs printing on the print sheet based on the print data transmitted from the general-purpose print software 202. At this time, the printing apparatus 102 can form the drawing data included in the print data on the print sheet by performing an operation according to the print setting attribute information included in the print data. The print setting attribute information includes, for example, print quality such as image quality priority or speed priority, attribute information for designating two-sided printing or one-sided printing, and the set values of the attribute information. For example, when the print setting attribute information includes attribute information designating the two-sided printing, the printing apparatus 102 can execute the two-sided printing.

Next, the configuration in which the expansion application 204 is associated with the general-purpose print software 202 and the printing apparatus 102 will be described with reference to FIG. 2B. As shown in FIG. 2B, unlike FIG. 2A, the expansion application 204 is added. That is, the host computer 101 includes the drawing application 201, the general-purpose print software 202, the print function information 203, and the expansion application 204. The expansion application 204 is software to expand the function of the general-purpose print software 202. The expansion application 204 is software that is not included in the OS 213 in advance (not packaged together). Therefore, the expansion application 204 is downloaded from a server (not shown) via the Internet and installed in the host computer 101 by the user operating the host computer 101.

Alternatively, the expansion application 204 may be automatically installed in the host computer 101 when the printing apparatus 102 is connected to the host computer 101. Specifically, when the printing apparatus 102 is connected to the host computer 101, the OS obtains device identification information from the printing apparatus 102. The OS may download the expansion application 204 corresponding to the device identification information from the server via the Internet and install the expansion application 204. As a result, the general-purpose print software 202 and the expansion application 204 are held as different control programs in the host computer 101.

The general-purpose print software 202 and the expansion application 204 may be updated and upgraded, respectively. In this case, an update process of the general-purpose print software 202 and an update process of the expansion application 204 may be performed at the same timing or different timings. A trigger to obtain the general-purpose print software 202 and a trigger to obtain the expansion application 204 by the host computer 101 may be the same or different. In addition, when the expansion application 204 is installed, the OS associates the expansion application 204 with the general-purpose print software 202 and the printing apparatus 102.

As illustrated in FIG. 2B, the expansion application 204 can exchange information (transmit and receive information) with the general-purpose print software 202 and with the printing apparatus 102. That is, the expansion application 204 is associated with the general-purpose print software 202 and the printing apparatus 102. In the present embodiment, the expansion application 204 includes a print-setting-screen expansion unit 205, a print function expansion unit 206, an intermediate data editing unit 207, and a notification unit 209. The expansion application 204 includes shared information 208 that can be accessed from each of the print-setting-screen expansion unit 205, the print function expansion unit 206, the intermediate data editing unit 207, and the notification unit 209. The shared information 208 is a file stored in the external storage device 114 or information stored in the RAM 113. The expansion application 204 can write and read information to and from the shared information 208 by using an API (Application Program Interface) provided by the OS.

The expansion application 204 may terminate the operation of the expansion application 204 as a whole in accordance with the end of the process of each of the print-setting-screen expansion unit 205, the print function expansion unit 206, the intermediate data editing unit 207, and the notification unit 209. In this case, the OS activates the expansion application 204 whenever a process execution request is received from each unit. In addition, the OS terminates the operation of the expansion application 204 as a whole, for example, in a case where the process of the print-setting-screen expansion unit 205 ends. In addition, the expansion application 204 may cancel the process during the process of each of the print-setting-screen expansion unit 205, the print function expansion unit 206, the intermediate data editing unit 207, and the notification unit 209. In this case, the OS deletes a job in processing on a print queue.

As described above, the drawing application 201 issues a print instruction to the OS in response to a print request from a user. In addition, the drawing application 201 can display the print setting screen. In the configuration shown in FIG. 2B, the drawing application 201 can display the print setting screen 300A (an advanced setting screen 300C) provided by the print-setting-screen expansion unit 205 (the expansion application 204). The print-setting-screen expansion unit 205 can store an advanced setting set by the user in the shared information 208.

The intermediate data editing unit 207 obtains intermediate data from the general-purpose print software 202. Then, the intermediate data editing unit 207 converts the intermediate data into the print data and then transmits the print data to the printing apparatus 102. The intermediate data editing unit 207 also obtains advanced setting information from the shared information 208 and adds the advanced setting to the print data. The printing apparatus 102 prints an image on a paper sheet based on the print data from the intermediate data editing unit 207. The expansion application 204 may be configured to obtain print data generated by the general-purpose print software 202 and add the advanced setting to the print data.

In addition, even in the configuration in FIG. 2B, the thickness adjustment setting may not be executed. In this case, the general-purpose print software 202 may transmit the print data to the printing apparatus 102 without passing through the expansion application 204.

The print function expansion unit 206 can edit the print function information 203 (PDC) generated by the general-purpose print software 202 or the OS. This enables addition of a function provided by the expansion application 204. In addition, it is possible to add a function (for example, a thickness adjustment function) that can be executed by the printing apparatus 102 but cannot be executed by the general-purpose print software 202 and to add an exclusive relationship between set values of print functions. The OS activates the print function expansion unit 206 when the expansion application 204 is associated with the printing apparatus 102 and the general-purpose print software 202 at first. Further, the OS may activate the print function expansion unit 206 at other timings (for example, at the time of activation of the OS). By such activation, even when the function related to printing is expanded later, the print function expansion unit 206 can detect the expanded function and add the expanded function to the print function information 203. As an example in which the function related to printing is expanded later, there is a case where an optional device (for example, a finisher) is added to the printing apparatus 102 later.

When an error occurs in the printing apparatus 102, the notification unit 209 can notify the user of the error. For example, when a no-sheet error occurs in the printing apparatus 102, the general-purpose print software 202 detects the occurrence of the error. The OS displays the occurrence of the no-sheet error, which is a detection result of the general-purpose print software 202, as a message on the display unit 119 by a notification function called toast notification, which is one of the functions of the OS. When the user operates the toast notification, the notification unit 209 is called by the OS, and a user interface screen (UI screen) of the notification unit 209 is displayed. On the user interface screen, for example, a detailed message related to the no-sheet error and a sheet replenishing method can be displayed.

As described above, in the present embodiment, the expansion application 204 has the following four functions. The first is a function of displaying a setting screen. This function is performed by the print-setting-screen expansion unit 205. The second is a function of editing the intermediate data to convert the intermediate data into the print data and adding the advanced setting to the print data. This function is performed by the intermediate data editing unit 207. The third is a function of expanding a function that can be designated by the print data generation software. This function is performed by the print function expansion unit 206. The fourth is a function of displaying a screen in response to occurrence of an error in the printing apparatus 102. This function is performed by the notification unit 209. The configuration of the expansion application 204 is not limited to the configuration having all the four functions described above. The expansion application 204 preferably has at least one of the functions, and may have another function. In addition, once the expansion application 204 transmits the print data to the printing apparatus 102, the expansion application 204 cannot display a screen such as a guide associated with the print data during the process of each unit.

FIG. 3A to FIG. 3D are views illustrating examples of print setting screens displayed on the display unit of the print system. FIG. 3A shows the print setting screen displayed by the drawing application 201. FIG. 3B shows the advanced setting screen that is displayed in a case where the expansion application 204 is not associated. FIG. 3C and FIG. 3D respectively show the advanced setting screens displayed in a case where the expansion application 204 is associated. Note that the units and modules that display the screens are not particularly limited. For example, the print-setting-screen expansion unit 205 may be configured to only generate the display screen. In such a case, the print-setting-screen expansion unit 205 transmits the generated display screen to the drawing application 201 via the general-purpose print software 202. The drawing application 201 may be configured to display the obtained display screen.

The print setting screen 300A shown in FIG. 3A is the screen on which a print condition relating to printing by the printing apparatus 102 can be set. The print setting screen 300A includes controls 301, 302, 303, 304, and 305. The control 301 allows a user to set the printing apparatus 102 used for printing, a print orientation by the printing apparatus 102, and the number of copies to be printed by the printing apparatus 102. In FIG. 3A, the printing apparatus 102 used for printing is set to “Printer 200a”, the print orientation by the printing apparatus 102 is set to “Portrait”, and the number of copies to be printed by the printing apparatus 102 is set to “1”, for example. In the control 302, a preview screen is displayed. The control 303 is a print button that allows a user to instruct the start of printing by the printing apparatus 102 when being pressed. The control 304 is a cancel button that allows a user to instruct cancellation of printing by the printing apparatus 102 when being pressed. The control 305 is an advanced setting button that allows a user to perform the advanced setting when being pressed.

In the case where the expansion application 204 is not associated, the advanced setting screen 300B shown in FIG. 3B is displayed when the user operates the control 305. The advanced setting screen 300B includes controls 306, 307, 308, and 309. The controls 306, 307, and 308 are arranged in a vertical direction on the upper side of the advanced setting screen 300B. The control 309 is located on the lower side of the advanced setting screen 300B. The control 306 allows the user to select and set a type of a sheet to be used in printing by the printing apparatus 102. In FIG. 3B, “Plain paper” is selected as an example. The control 307 allows the user to select and set a sheet size used in printing by the printing apparatus 102. In FIG. 3B, “A4” is selected as an example. The control 308 allows the user to select a sheet feed port to be used in printing by the printing apparatus 102. In FIG. 3B, “Auto” is selected as an example. The control 309 allows the user to finish the settings by the controls 306 to 308. Further, when the user operates the control 309, the display returns to the print setting screen 300A shown in FIG. 3A.

In the case where the expansion application 204 is associated, the advanced setting screen (a setting reception screen) 300C shown in FIG. 3C is displayed (a display control step) when the user presses (operates) the control 305. The advanced setting screen 300C is a screen displayed together with the print setting screen 300A, but its display mode is not particularly limited. For example, the advanced setting screen 300C may be displayed over the print setting screen 300A, the advanced setting screen 300C may be displayed adjacent to the print setting screen 300A, or the advanced setting screen 300C may be displayed after the print setting screen 300A disappears once.

The advanced setting screen 300C is used to accept the thickness adjustment setting. The advanced setting screen 300C includes the controls 306 to 309 as with the advanced setting screen 300B. In addition, controls 310, 312, and 313 as the thickness adjustment setting are added to and included in the advanced setting screen 300C. The control 310 is a setting selector to select whether the thickness adjustment setting is enabled or disabled. When the control 310 is pressed, a list 311 including “Yes” indicating that the thickness adjustment setting is enabled and “No” indicating that the thickness adjustment setting is disabled is displayed. Then, a desired choice can be selected from “Yes” and “No”. In FIG. 3C, “Yes” is selected as an example.

The control 312 is an operation button to display an advanced setting screen (setting reception screen) 300D (see FIG. 3D) on which advanced setting of the thickness adjustment can be performed. When the control 312 is pressed, the advanced setting screen 300D is displayed. A display mode of the advanced setting screen 300D is not particularly limited. For example, the advanced setting screen 300D may be displayed over the advanced setting screen 300C, the advanced setting screen 300D may be displayed adjacent to the advanced setting screen 300C, or the advanced setting screen 300D may be displayed after the advanced setting screen 300C disappears once. The control 313 is a forced restoration button (a forced restoration item) to forcibly restore the advanced setting of the thickness adjustment set on the advanced setting screen 300D to an initial state (a standard state). When the control 313 is pressed, the advanced setting of the thickness adjustment on the advanced setting screen 300D can be performed again from the initial state.

The advanced setting screen 300D includes controls 315, 317, 319, 321, 323, and 324. The control 315 is a thickness selector to select a set value of an option “Thickening width” (hereinafter also referred to as a thickness adjustment amount) of a line. When the control 315 is pressed, a list 316 is displayed. The list 316 includes “-1” for reducing the thickness (thickening width) of the line by one pixel, “0” for not changing the thickness (thickening width) of the line, “+1” for increasing the thickness (thickening width) of the line by one pixel, and “+2” for increasing the thickness (thickening width) of the line by two pixels. Then, a desired set value can be selected from among “-1”, “0”, “+1”, and “+2”. In FIG. 3D, “-1” is selected as an example. The thickness adjustment of the line set by the control 315 is not limited to the selection from the plurality of set values, and may be input of a desired numerical value within a range between an upper limit value and a lower limit value, for example.

The control 317 is a setting selector to select whether a thickness adjustment setting for an option “Character” is enabled or disabled. When the control 317 is pressed, a list 318 including “Yes” indicating that the thickness adjustment setting for the option “Character” is enabled and “No” indicating that the thickness adjustment setting for the option “Character” is disabled is displayed. Then, a desired choice can be selected from “Yes” and “No”. In FIG. 3D, “Yes” is selected as an example. In this case, the thickness of the character can be adjusted by the numerical value selected in the list 316. The control 319 is a setting selector to select whether a thickness adjustment setting for an option “Ruled line” is enabled or disabled. When the control 319 is pressed, a list 320 including “Yes” indicating that the thickness adjustment setting for the option “Ruled line” is enabled and “No” indicating that the thickness adjustment setting for the option “Ruled line” is disabled is displayed. Then, a desired choice can be selected from “Yes” and “No”. In FIG. 3D, “No” is selected as an example. In this case, the thickness adjustment setting for the option “Ruled line” is regulated.

The control 321 is a setting selector to select whether a thickness adjustment setting for an option “Graphic” is enabled or disabled. When the control 321 is pressed, a list 322 including “Yes” indicating that the thickness adjustment setting for the option “Graphic” is enabled and “No” indicating that the thickness adjustment setting for the option “Graphic” is disabled is displayed. Then, a desired choice can be selected from “YES” and “NO”. In FIG. 3D, “No” is selected as an example. In this case, the thickness adjustment for the option “Graphic” is restricted. The thickness adjustment for the option “Graphic” is not particularly limited. For example, the thickness of characters, ruled lines, or contours included in a graphic may be adjusted. Although the options (targets) of the thickness adjustment include “Character”, “Ruled line”, and “Graphic” in the present embodiment, the options are not limited thereto, and at least one of these may be included, or other options may be included. The control 323 is an OK button to save the settings on the advanced setting screen 300D to the external storage device 114 and exit when being pressed. The control 324 is a cancel button to exit without saving the settings on the advanced setting screen 300D when being pressed.

Here, the reason why the items included in the advanced setting screen 300B shown in FIG. 3B and the items included in the advanced setting screen 300C shown in FIG. 3C are different will be described. The advanced setting screen 300B and the advanced setting screen 300C are generated based on the print function information (capability information). As described above, the general-purpose print software 202 does not support the execution of the thickness adjustment function. Therefore, the thickness adjustment function cannot be added to the print function information only by the general-purpose print software 202. In addition, even if the thickness adjustment function is originally included in the print function information, the general-purpose print software 202 cannot interpret the thickness adjustment function included in the print function information. Therefore, the setting of the thickness adjustment function cannot be displayed on the advanced setting screen. Therefore, the print function expansion unit 206 adds the thickness adjustment function to the print function information 203. Then, the print-setting-screen expansion unit 205 refers to the capability information and displays the advanced setting screen 300C. Accordingly, the expansion application 204 can display the setting of the thickness adjustment function on the advanced setting screen.

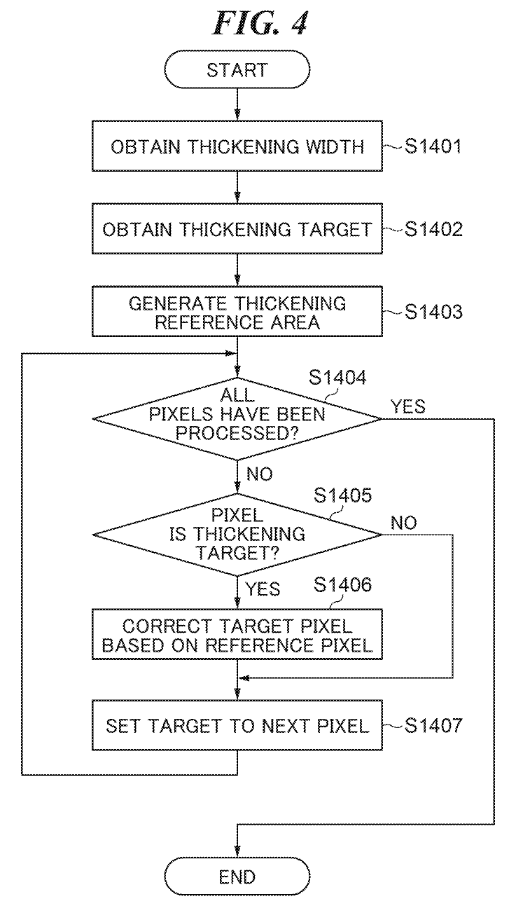

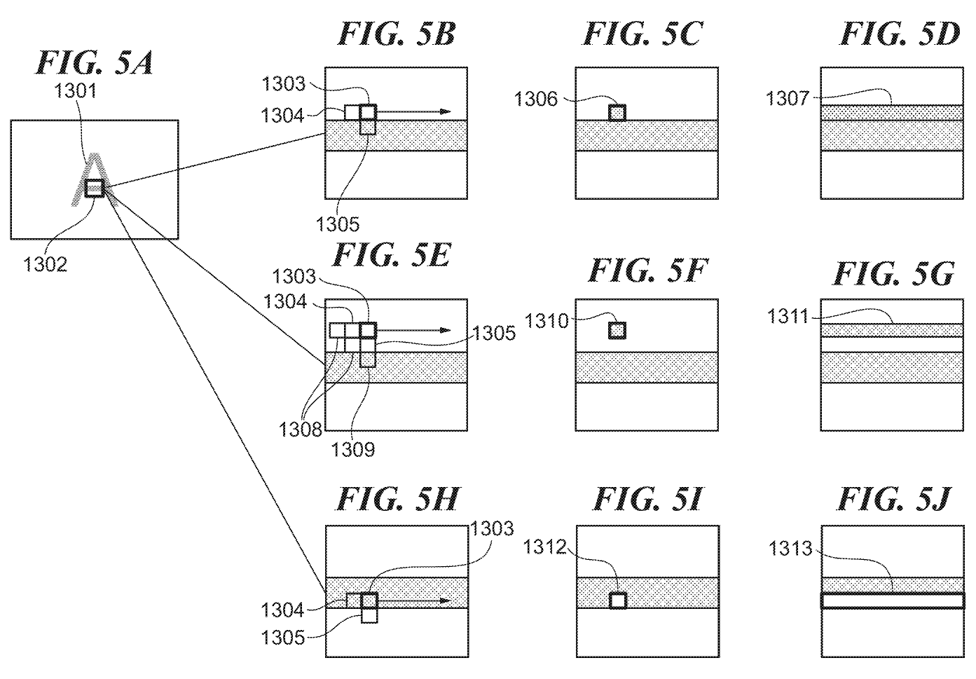

FIG. 4 is a flowchart illustrating a thickness adjustment process. FIG. 5A to FIG. 5J are image diagrams indicating an outline of the thickness adjustment process. As illustrated in FIG. 4, in a step S1401, the CPU 111 of the host computer 101 obtains a set value for the option “Thickening width” (thickness adjustment amount). This set value is obtained from the choice selected in the list 316 on the advanced setting screen 300D.

In a step S1402, the CPU 111 obtains information about a thickening target (an option, a thickness adjustment target). The information is obtained from the options “Character”, “Ruled line”, and “Graphic” for which “YES” is selected in the lists 318, 320, and 322 on the advanced setting screen 300D. For example, a horizontal line 1302 of a character 1301 shown in FIG. 5A can be set as the thickness adjustment target.

In a step S1403, the CPU 111 generates reference areas in which the thickness adjustment process (thickening process) is performed. For example, when the set value for the thickness adjustment amount obtained in the step S1401 is “+1”, a reference pixel 1304 on a left side of a target pixel 1303 and a reference pixel 1305 on a lower side of the target pixel 1303 are generated as a reference area as shown in FIG. 5B. When the thickness adjustment amount obtained in the step S1401 is “+2”, two reference pixels 1308 on the left side and lower side of the reference pixel 1304 and a reference pixel 1309 on the lower side of the reference pixel 1305 are generated in addition to the reference pixels 1304 and 1305 as the reference area with respect to the target pixel 1303 as shown in FIG. 5E. In addition, when the thickness adjustment amount obtained in the step S1401 is “-1”, the reference pixel 1304 on the left side of the target pixel 1303 and the reference pixel 1305 on the lower side of the target pixel 1303 are generated as the reference area as shown in FIG. 5H.

In a step S1404, the CPU 111 determines whether all the pixels included in the image of the thickness adjustment target have been subjected to the thickness adjustment process. As a result of the determination in the step S1404, when it is determined that all the pixels have been processed, the process ends. On the other hand, as a result of the determination in the step S1404, when it is determined that not all the pixels have not been processed, the process proceeds to a step S1405.

In the step S1405, the CPU 111 determines whether the target pixel is a thickness adjustment target (thickening target). As a result of the determination in the step S1405, when it is determined that the target pixel is the thickness adjustment target, the process proceeds to a step S1406. On the other hand, as a result of the determination in the step S1405, when it is determined that the target pixel is not the thickness adjustment target, the process proceeds to a step S1407. For example, when the thickness adjustment amount is “+1” or “+2”, if the target pixel constitutes a character other than the character 1301 in the reference area, it is determined in the step S1405 that the target pixel is the thickness adjustment target, and the process proceeds to the step S1406. On the other hand, when the thickness adjustment amount is “+1” or “+2”, if there is no character in the reference area, it is determined in the step S1405 that the target pixel is not the thickness adjustment target, and the process proceeds to the step S1407. When the thickness adjustment amount is “-1”, if the target pixel is located on a character and an object other than a character is included in the reference area, it is determined in the step S1405 that the target pixel is the thickness adjustment target, and the process proceeds to the step S1406.

In the step S1406, the CPU 111 corrects the target pixel based on the reference pixels. For example, when the thickness adjustment amount is “+1” or “+2”, the target pixel is corrected based on the reference pixel in a combination in which the target pixel does not constitute a character and the reference pixel constitutes a character. That is, when the thickness adjustment amount is “+1”, the target pixel 1303 that does not constitute the character in FIG. 5B is corrected based on the reference pixel 1305 that constitutes the character to be a target pixel 1306 in FIG. 5C. Similarly, when the thickness adjustment amount is “+2”, the target pixel 1303 that does not constitute a character in FIG. 5E is corrected based on the reference pixel 1309 that constitutes the character to be a target pixel 1310 in FIG. 5F. When the thickness adjustment amount is “-1”, the target pixel 1303 that constitutes the character in FIG. 5H is corrected based on the reference pixel 1305 that does not constitute the character to be a target pixel 1312 in FIG. 5I.

The CPU 111 moves the target pixel to the next pixel in the step S1407 and the process returns to the step S1404. As a result of the determination in the step S1404, when it is determined that the process has been performed for all the pixels, the process ends. Accordingly, the thickness adjustment target in the case where the thickness adjustment amount is “+1” becomes a line 1307 in FIG. 5D. Similarly, the thickness adjustment target in the case where the thickness adjustment amount is “+2” becomes a line 1311 in FIG. 5G. When the thickness adjustment amount is “-1”, the thickness adjustment target becomes a line 1313 in FIG. 5J.

The thickness adjustment process is not limited to the process of the flowchart illustrated in FIG. 4. For example, there is another thickness adjustment process that extracts only a thin line or a rectangle of a single line in a PDL (Page Description Language) and changes the extracted line to a double line. When only a relatively thin line such as a ruled line is subjected to the thickness adjustment, if an object is determined as a one-pixel object or a two-pixel object, the thickness adjustment process is performed. In addition, when the thickness of only a character of a specific color is adjusted, the thickness adjustment process is performed only on a specific color plate after performing a color conversion process. In this way, a different process is required depending on a thickness adjustment target. The thickness adjustment process may be performed by the printing apparatus 102. The thickness adjustment process may be performed on an RGB image or may be performed after converting into a CMYK image.

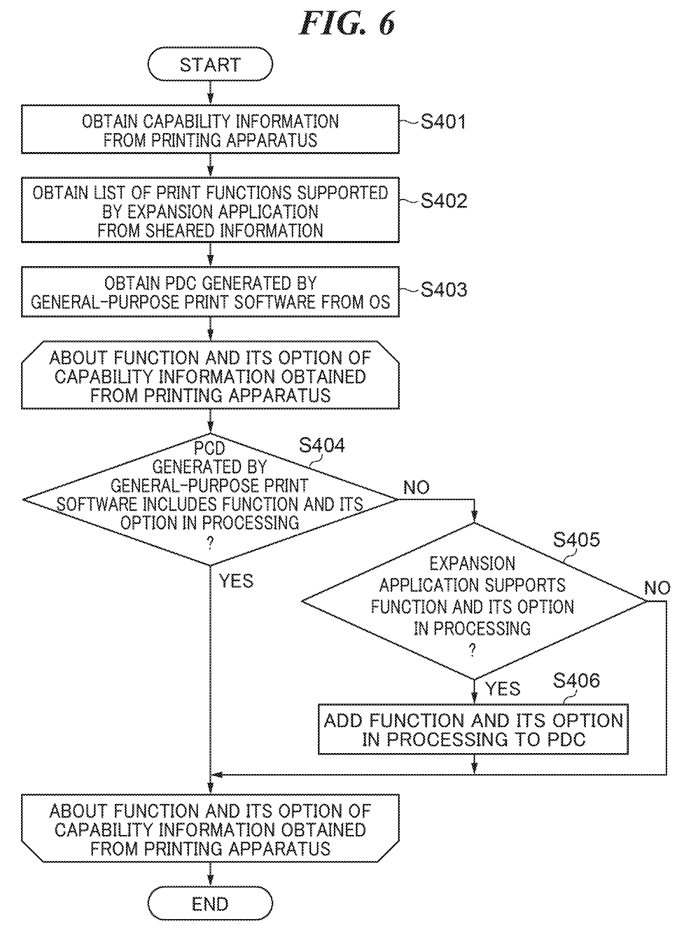

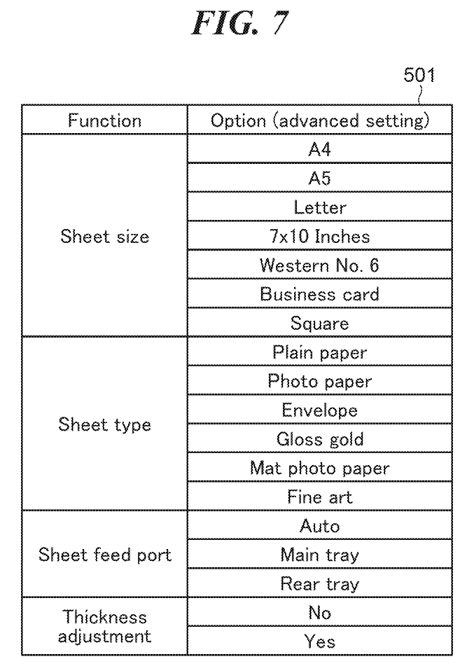

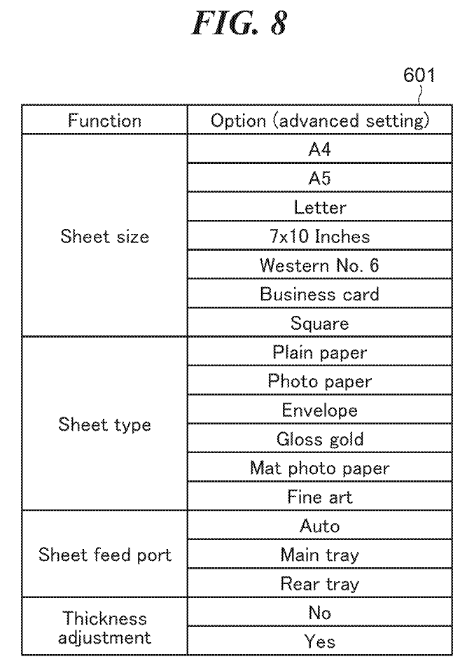

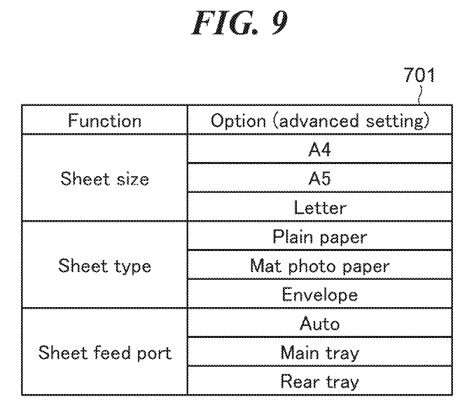

FIG. 6 is a flowchart illustrating a process in which the print function expansion unit edits the print function information. Note that a program based on the flowchart shown in FIG. 6 is executed by the CPU 111 controlling the print function expansion unit 206. FIG. 7 is a view illustrating an example of a list of capability information of the printing apparatus. FIG. 8 is a view illustrating an example of a list of print functions supported by the expansion application. FIG. 9 is a view illustrating an example of a list of capability information about the general-purpose print software.

As shown in FIG. 6, the print function expansion unit 206 obtains the capability information from the printing apparatus 102 in a step S401 (an obtaining step) prior to the display control step described above. The capability information is information related to the capability of the printing apparatus 102 to perform printing, and in the present embodiment, is a set value included in a response obtained by issuing an IPP “Get-Printer-Attributes” operation to the printing apparatus 102. The set value relates to a function that can be designated in the printing apparatus 102 and its attribute information.

A table 501 illustrated in FIG. 7 shows a list of pieces of capability information of the printing apparatus 102. The capability information includes, for example, information related to a sheet size used in printing by the printing apparatus 102. In addition, there are information related to a sheet type (medium) used in printing by the printing apparatus 102, information related to a sheet feed port used in printing by the printing apparatus 102, and information related to the thickness adjustment function that can be executed by the printing apparatus 102.

In a step S402, the print function expansion unit 206 obtains the print function supported by the expansion application 204 from the shared information 208. The shared information 208 stores a list of print functions supported by the expansion application 204. The list includes all print functions that can be processed by the expansion application 204 and their set values. A table 601 shown in FIG. 8 includes information about sheet sizes supported by the expansion application 204 as a print function. In addition, there are information related to sheet types supported by the expansion application 204, information related to sheet feed ports supported by the expansion application 204, and information related to the thickness adjustment function supported by the expansion application 204. The print function supported by the expansion application 204 may be updated by updating the expansion application 204.

In a step S403, the print function expansion unit 206 obtains the print function information 203 generated by the general-purpose print software 202 from the OS. The general-purpose print software 202 generates the print function information 203 based on the capability information (see the table 501) obtained from the printing apparatus 102. The print function information (PDC) 203 generated by the general-purpose print software 202 includes only the print function supported by the general-purpose print software 202 among the capability information obtained from the printing apparatus 102. For example, the table 601 illustrated in FIG. 8 includes “7x10 Inches” and “Western No. 6” are included as the sheet sizes, but the general-purpose print software 202 does not support such sheet sizes. Therefore, a table 701 illustrated in FIG. 9 that shows the print function information 203 does not include such sheet sizes.

Also, the table 601 shown in FIG. 8 includes the information about the thickness adjustment function, but the general-purpose print software 202 does not support the thickness adjustment function. Accordingly, the table 701 shown in FIG. 9, which shows the print function information 203, does not include the thickness adjustment function. The expansion application 204 can supply a function shortage of the general-purpose print software 202 by the print function expansion unit 206 adding a function and its option to the print function information 203. The print function expansion unit 206 can also delete an unnecessary function or option from the print function information 203 generated by the general-purpose print software 202.

Steps S404, S405, and S406 are processes that are repeatedly performed on the list of functions included in the capability information obtained from the printing apparatus 102 in the step S401. In the present embodiment, the steps S404, S405, and S406 are repeated for all 18 options included in the table 501.

In the step S404, the print function expansion unit 206 determines whether the print function information 203 generated by the general-purpose print software 202 includes a function and its option currently processed. As a result of the determination in the step S404, when it is determined that the print function information 203 includes the function and its option, the process ends if the last item of the options is processed. Alternatively, when the option currently processed is not the last item of the options, the next item of the options is selected and the process from the step S404 is performed again.

On the other hand, when it is determined in the step S404 that the print function information 203 does not include the function and its option currently processed, the process proceeds to the step S405. For example, in the present embodiment, the table 501 includes the function “Sheet size” and its option “A4”, and the table 701 also includes the function “Sheet size” and its option “A4”. In this case, it is determined in the step S404 that he print function information 203 includes the function and its option currently processed. In contrast, the table 501 includes the function “Thickness adjustment”, but the table 701 does not include the function “Thickness adjustment”. In this case, it is determined in the step S404 that the print function information 203 does not include the function and its option currently processed.

In the step S405, the print function expansion unit 206 determines whether the functions and their options supported by the expansion application 204 include the function and its option currently processed, that is, whether the expansion application 204 supports the function and its option in processing. When it is determined in the step S405 that the expansion application supports the function and its option in processing, the process proceeds to a step S406. On the other hand, when it is determined in the step S405 that the expansion application 204 does not support the function and its option in processing, the process is terminated when the option currently processed is the last item of the options, as in the case where “Yes” is determined in the step S404. Alternatively, when the option currently processed is not the last item of the options, the next item of the options is selected and the process in the step S404 is performed again. For example, in the present embodiment, when the function currently being processed is the function “Thickness adjustment”, the table 601 also includes the function “Thickness adjustment”. Therefore, it is determined in step S405 that the expansion application 204 support the function in processing.

In the step S406, the print function expansion unit 206 adds the currently processed function and its option to the print function information 203. After the step S406 is executed, if the last item in the options is being processed, the process is terminated, as in the case where “Yes” is determined in the step S404. Alternatively, when the option currently processed is not the last item of the options, the next item of the options is selected and the process from the step S404 is performed again.

As described above, the expansion application 204 can add, to the print function information 203, a function and its option that are not supported by the general-purpose print software 202, are supported by the printing apparatus 102, and are supported by the expansion application 204. Then, the capability information (PC) is generated based on the print function information 203 edited by the addition process. The print-setting-screen expansion unit 205 can display the advanced setting screen 300C by generating the display screen based on the capability information and expanding the capability to the function that is not supported by the general-purpose print software 202.

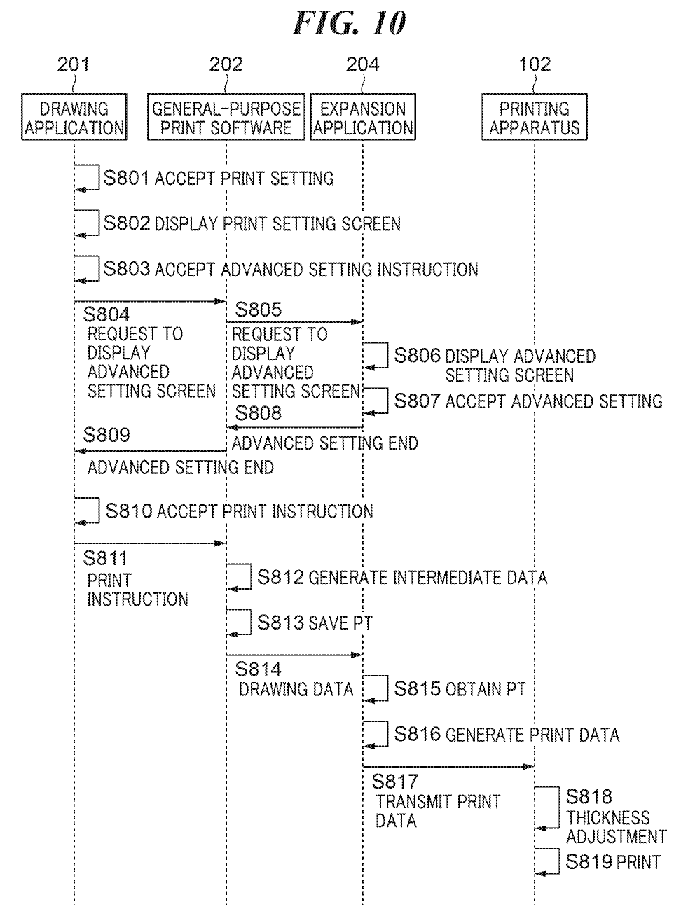

FIG. 10 is a sequence chart illustrating a process executed among the drawing application, the general-purpose print software, the expansion application, and the printing apparatus after the drawing application accepts a print setting. The processes of the drawing application, general-purpose print software, and expansion application are executed by the CPU 111 of the host computer 101. The process program is stored in the external storage device 114. Then, the CPU 111 reads the process program from the external storage device 114 to the RAM 113 and executes the process program. The process of the printing apparatus 102 is executed by a CPU (not shown) of the printing apparatus 102. Further, the print system 1000 has the software configuration shown in FIG. 2B.

As shown in FIG. 10, the drawing application 201 accepts a print setting by a user in a step S801. The user can instruct the drawing application 201 to execute the print setting by operating, for example, the pointing device 117 or the keyboard 118.

In a step S802, the drawing application 201 displays the print setting screen 300A shown in FIG. 3A on the display unit 119.

In a step S803, the drawing application 201 receives an advanced setting instruction by the user. The user can instruct the advanced setting by selecting the control 305 on the print setting screen 300A by operating, for example, the pointing device 117 or the keyboard 118.

In a step S804, the drawing application 201 requests the general-purpose print software 202 to display the advanced setting screen.

In a step S805, the general-purpose print software 202 requests the expansion application 204 to display the advanced setting screen.

In a step S806, the print-setting-screen expansion unit 205 of the expansion application 204 displays the advanced setting screen 300C shown in FIG. 3C. As described above, the thickness adjustment function is added to the print function information 203 (PDC) by the print function expansion unit 206. The print-setting-screen expansion unit 205 can display the advanced setting screen 300C by referring to the capability information (PC) generated based on the added print function information 203.

In a step S807, the print-setting-screen expansion unit 205 accepts the advanced setting on the advanced setting screen 300C by the user. Here, the sheet type “Plain paper” is selected in the control 306, the sheet size “A4” is selected in the control 307, and the sheet feed port “Auto” is selected in the control 308 on the advanced setting screen 300C (see FIG. 3C). In addition, the thickness adjustment “YES” is selected in the control 310 (see FIG. 3C). In this setting state (selection state), the print-setting-screen expansion unit 205 accepts an operation of the control 309 on the advanced setting screen 300C by the user. As a result, the advanced setting screen 300D shown in FIG. 3D is displayed. Then, the print-setting-screen expansion unit 205 accepts the advanced setting on the advanced setting screen 300D by the user.

Here, the thickness adjustment amount “-1” is selected as the set value for the option “Thickening width” in the control 315 on the advanced setting screen 300D. The choice “Yes” is selected for the option “Character” in the control 317, the choice “No” is selected for the option “Ruled line” in the control 319, and the choice “No” is selected for the option “Graphic” in the control 321. In this setting state, the print-setting-screen expansion unit 205 accepts the operation of the control 323 on the advanced setting screen 300D by the user. This completes the advanced setting. The user can instruct the end of the advanced setting by selecting the control 323 by, for example, operating the pointing device 117 or the keyboard 118.

In the step S808, the expansion application 204 transmits advanced setting end information indicating the end of the advanced setting in the step S807 to the general-purpose print software 202.

In a step S809, the general-purpose print software 202 receives the advanced setting end information transmitted from the expansion application 204 in the step S808 and transmits the advanced setting end information to the drawing application 201.

In a step S810, the drawing application 201 accepts a print instruction by the user. The user can issue the print instruction by operating, for example, the pointing device 117 or the keyboard 118 to select the control 303 on the print setting screen 300A (see FIG. 3A).

In a step S811, the drawing application 201 transmits the print instruction accepted in the step S811 to the general-purpose print software 202.

In step S812, the general-purpose print software 202 generates intermediate data based on the print instruction in the step S811 using a module of the OS.

In a step S813, the general-purpose print software 202 saves the print setting information (PT) based on the print instruction in the step S811 in the shared information 208.

In a step S814, the general-purpose print software 202 transmits drawing data (image data) included in the intermediate data generated in the step S813 to the expansion application 204.

In a step S815, the intermediate data editing unit 207 of the expansion application 204 obtains the print setting information saved in the step S813 from the shared information 208.

In a step S816, the intermediate data editing unit 207 of the expansion application 204 generates print data using the drawing data transmitted in the step S814 and the print setting information obtained in the step S815. The print data includes the set value of the thickness adjustment (the numerical value information) accepted in the step S807.

In a step S817, the intermediate data editing unit 207 of the expansion application 204 transmits the print data generated in the step S816 to the printing apparatus 102 (a transmission process). As described above, the print data includes the set value of the thickness adjustment accepted in the step S807. In addition, this transmission enables to instruct the printing apparatus 102 to execute printing based on the thickness adjustment setting (an instruction step).

In a step S818, the printing apparatus 102 receives the print data transmitted in the step S817. The printing apparatus 102 interprets the print data and applies a necessary image process to the print data. As the image process here, the thickness adjustment is performed on the print data based on the numerical value information included in the print data transmitted in the step S817. Accordingly, data including an image of any one of the line 1307 in FIG. 5D, the line 1311 in FIG. 5G, and the line 1313 in FIG. 5J is generated, for example.

In a step S819, the printing apparatus 102 prints the print data subjected to the image process in the step S818. As a result, the printed matter of the print data subjected to the thickness adjustment can be obtained.

As described above, in the print system 1000, even when the general-purpose print software 202 does not support the thickness adjustment setting, the expansion application 204 can display the advanced setting screen 300C shown in FIG. 3C. The advanced setting screen 300C enables the printing apparatus 102 to execute the thickness adjustment. As a result, the printing apparatus 102 can output a printed matter of print data subjected to the thickness adjustment.

The description referring to FIG. 10 assumes that the print system 1000 employs the software configuration shown in FIG. 2B and displays the advanced setting screen 300C shown in FIG. 3C, but this is not limited. For example, when the general-purpose print software 202 is requested to display the advanced setting screen in the step S804, the general-purpose print software 202 displays the advanced setting screen 300B shown in FIG. 3B. In this case, the general-purpose print software 202 requests the expansion application 204 to display the additional advanced setting screen when the control 309 on the advanced setting screen 300B is operated. Next, the expansion application 204 may additionally display an advanced setting screen in which the thickness adjustment setting can be performed. In addition, the expansion application 204 generates the print data from the intermediate data generated by the general-purpose print software 202 in the present embodiment, but this is not limited, and for example, the expansion application 204 itself may generate the intermediate data.

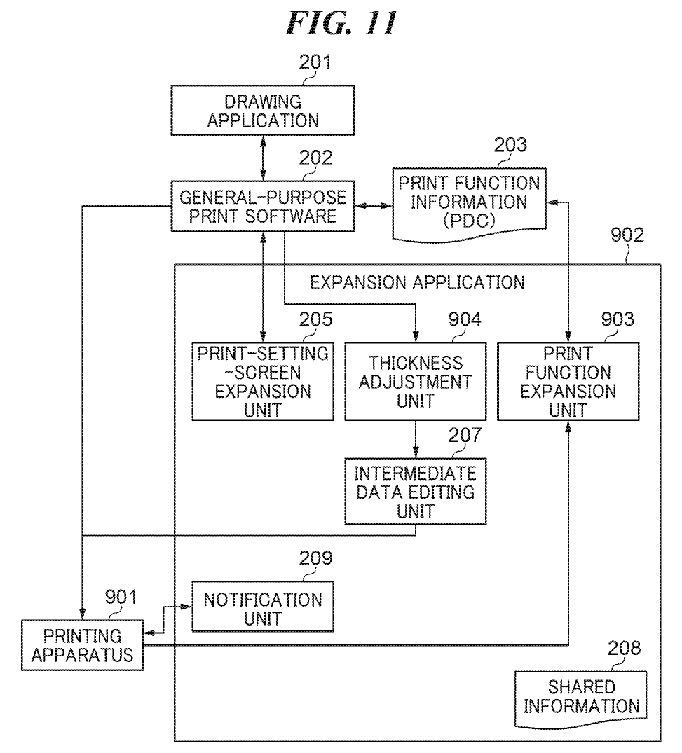

Hereinafter, a second embodiment will be described with reference to FIG. 11 to FIG. 13. Differences from the above-described embodiment will be mainly described, and the description of the same matters will be omitted. In the first embodiment, the expansion application 204 generates the print data including the thickness adjustment setting together with the general-purpose print software 202. This print data is transmitted to the printing apparatus 102. The printing apparatus 102 can interpret the print data including the thickness adjustment setting and execute the thickness adjustment. In this manner, in the first embodiment, the expansion application 204 causes the printing apparatus 102 to execute the thickness adjustment together with the general-purpose print software 202.

However, some printing apparatuses cannot execute the thickness adjustment. In the second embodiment, a printing apparatus shall be not able to execute the thickness adjustment. In this case, even if the expansion application generates the print data including the thickness adjustment setting, the printing apparatus cannot perform the thickness adjustment. Therefore, it is preferable that the expansion application generates the print data subjected to the thickness adjustment and transmits the print data to the printing apparatus.

In the present embodiment, it is determined whether the printing apparatus can execute the thickness adjustment on the basis of the capability information of the printing apparatus. As a result of this determination, when it is determined that the printing apparatus can execute the thickness adjustment, the expansion application generates the print data including the thickness adjustment setting and transmits the print data to the printing apparatus. On the other hand, when it is determined that the printing apparatus cannot execute the thickness adjustment, the expansion application generates the print data in which the thickness adjustment has been performed on the drawing data and transmits the print data to the printing apparatus. This allows the user to provide the thickness adjustment even if the printing apparatus cannot execute the thickness adjustment. The present embodiment is the same as the first embodiment except the configuration of the print system in the case where the expansion application is associated, the editing process of the PDC, and the process after the drawing application 201 accepts the print setting.

FIG. 11 is a block diagram illustrating a software configuration of a print system according to the second embodiment. The block diagram shown in FIG. 11 illustrates the configuration in the case where an expansion application 902 is associated with the general-purpose print software 202 and a printing apparatus 901. As shown in FIG. 11, the host computer 101 includes the drawing application 201, the general-purpose print software 202, the print function information 203, and the expansion application 902. The expansion application 902 is communicably connected to the printing apparatus 901.

The printing apparatus 901 is different from the printing apparatus 102 in the first embodiment and cannot execute the thickness adjustment. The expansion application 902 includes the print-setting-screen expansion unit 205, the intermediate data editing unit 207, the shared information 208, the notification unit 209, a print function expansion unit 903, and a thickness adjustment unit 904. Even when it is determined that the printing apparatus 102 cannot execute the thickness adjustment on the basis of the capability information obtained from the printing apparatus 901, the print function expansion unit 903 can add the information related to the thickness adjustment to the print function information 203. The thickness adjustment unit 904 performs the thickness adjustment on the intermediate data received from the general-purpose print software 202 on the basis of the thickness adjustment setting.

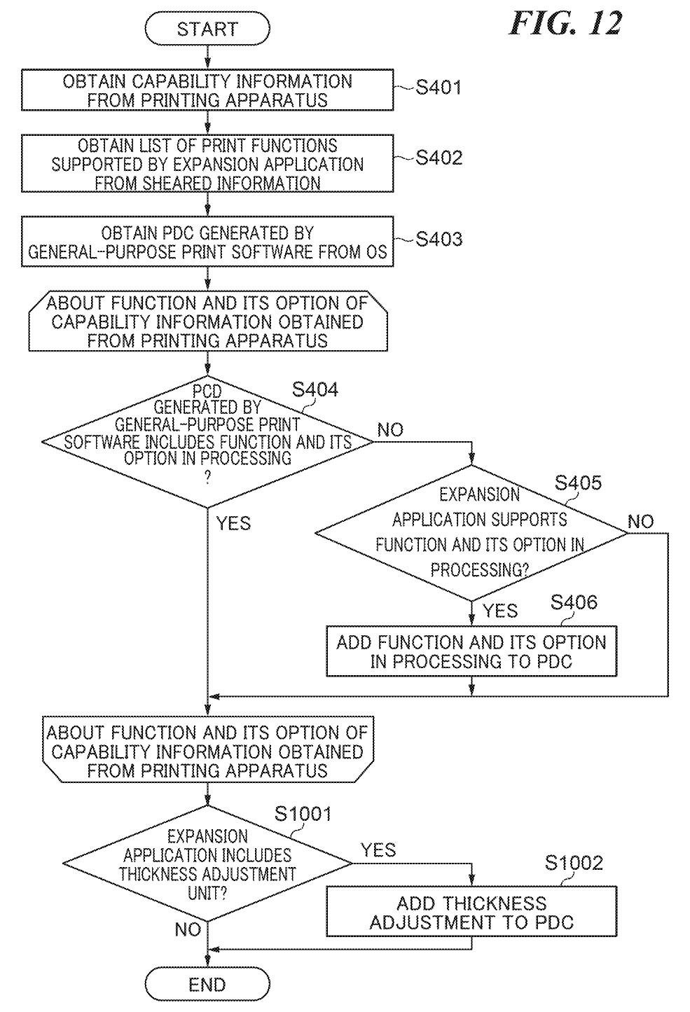

FIG. 12 is a flowchart illustrating a process in which the print function expansion unit edits print function information. Note that a program based on the flowchart shown in FIG. 12 is executed by the CPU 111 controlling the print function expansion unit 903. In addition, the flowchart shown in FIG. 12 is configured by adding a step S1001 and a step S1002 to the flowchart shown in FIG. 6. As shown in FIG. 12, when the repetitive process from the step S404 to the step S406 is completed, the process proceeds to the step S1001. As described above, the printing apparatus 901 cannot execute the thickness adjustment. Therefore, the thickness adjustment function is not added to the print function information 203 after the process from the step S404 to the step S406 is completed.

As shown in FIG. 12, in the step S1001, the print function expansion unit 903 determines whether the thickness adjustment unit 904 is included in the expansion application 902. As a result of the determination in the step S1001, when it is determined that the thickness adjustment unit 904 is included, the process proceeds to the step S1002. On the other hand, as a result of the determination in the step S1001, when it is determined that the thickness adjustment unit 904 is not included, the process ends. As described above, since the expansion application 902 includes the thickness adjustment unit 904, the process proceeds to the step S1002.

In the step S1002, the print function expansion unit 903 adds information related to the thickness adjustment to the print function information 203.

As described above, the expansion application 902 can add, to the print function information 203, a function and its option that are not supported by the general-purpose print software 202, are supported by the printing apparatus 901, and are supported by the expansion application 902. Then, the expansion application 902 determines whether the thickness adjustment unit 904 is included. As a result of this determination, when it is determined that the thickness adjustment unit 904 is included, the thickness adjustment function is added to the print function information 203. This addition process allows generation of the capability information based on the print function information 203 to which the thickness adjustment function is added, even when the printing apparatus 901 cannot execute the thickness adjustment. The expansion application 902 can display the advanced setting screen 300C shown in FIG. 3C by generating a display screen on the basis of the capability information.

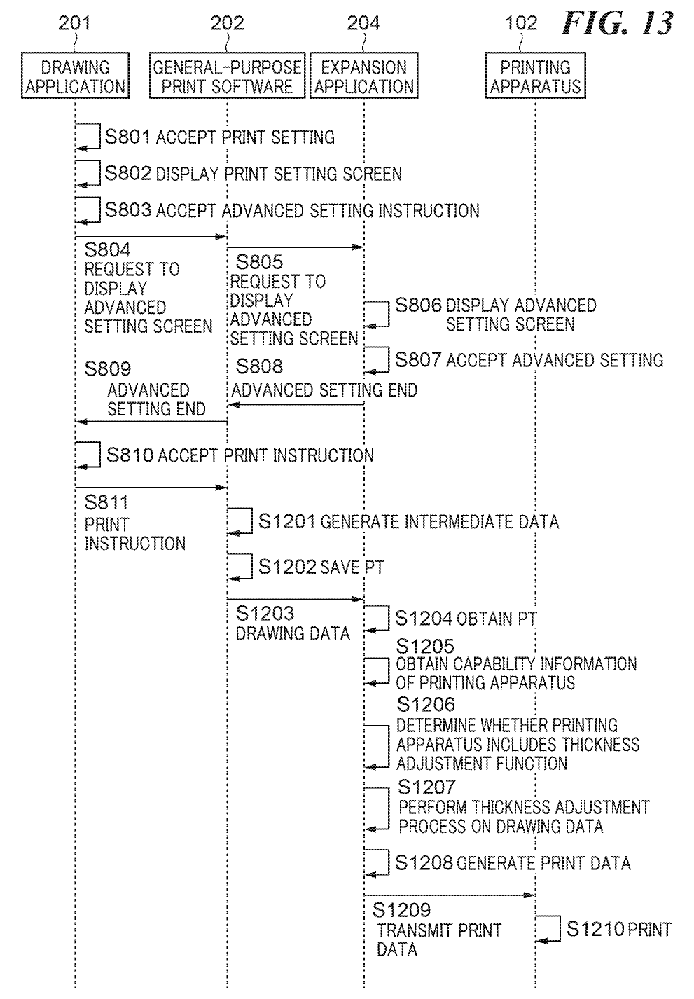

FIG. 13 is a sequence chart illustrating a process executed among the drawing application, the general-purpose print software, the expansion application, and the printing apparatus after the drawing application accepts a print setting. In the sequence chart shown in FIG. 13, unlike the sequence chart shown in FIG. 10, steps S1201 to S1210 are executed in order instead of the steps S812 to S819. As shown in FIG. 13, after the process in the step S811 is executed, the process proceeds to the step S1201.

In the step S1201, the general-purpose print software 202 generates intermediate data based on the print instruction in the step S811 using a module of the OS.

In the step S1202, the general-purpose print software 202 saves the print setting information based on the print instruction in the step S811 in the shared information 208.

In the step S1203, the general-purpose print software 202 transmits drawing data included in the intermediate data generated in the step S1201 to the expansion application 902.

In the step S1204, the thickness adjustment unit 904 of the expansion application 902 obtains the print setting information saved in the step S1202 from the shared information 208. Further, the thickness adjustment unit 904 obtains information related to the thickness adjustment setting from the print setting information.

In the step S1205, the thickness adjustment unit 904 obtains the capability information of the printing apparatus 901 from the shared information 208. In a case where the capability information of the printing apparatus 901 is not stored in the shared information 208, the print function expansion unit 903 can request the capability information from the printing apparatus 901 and store the information in the shared information 208.

In the step S1206, the thickness adjustment unit 904 determines whether the capability information obtained in the step S1205 shows that the printing apparatus 901 has the thickness adjustment function (a determination step). In the present embodiment, the printing apparatus 901 does not have the thickness adjustment function. Therefore, it is determined in the step S1206 that the printing apparatus 901 does not have the thickness adjustment function. In this case, the process proceeds to the step S1207. If it is determined in the step S1206 that the printing apparatus 901 has the thickness adjustment function, the process proceeds to the step S1208 while skipping the step S1207.

In the step S1207, the thickness adjustment unit 904 performs the thickness adjustment on the print data on the basis of the information related to the thickness adjustment setting obtained in the step S1204, and stores the print data subjected to the thickness adjustment in the shared information 208. The thickness adjustment unit 904 edits the set value of the thickness adjustment in the print setting information to “0” or deletes the setting of the thickness adjustment from the print setting information.

In the step S1208, the intermediate data editing unit 207 generates printable print data (a generation control step) using the print data subjected to the thickness adjustment that is stored in the shared information 208 in the step S1207 and the print setting information obtained in the step S1204. The print data (image data) is based on the thickness adjustment setting accepted on the advanced setting screen 300C and the advanced setting screen 300D.

In the step S1209, the intermediate data editing unit 207 of the expansion application 902 transmits the print data generated in the step S1208 to the printing apparatus 901 (a transmission step).

In the step S1210, the printing apparatus 901 interprets the print data transmitted in the step S1209, performs a necessary image process on the print data, and then performs printing. As a result, the printed matter of the print data subjected to the thickness adjustment can be obtained.

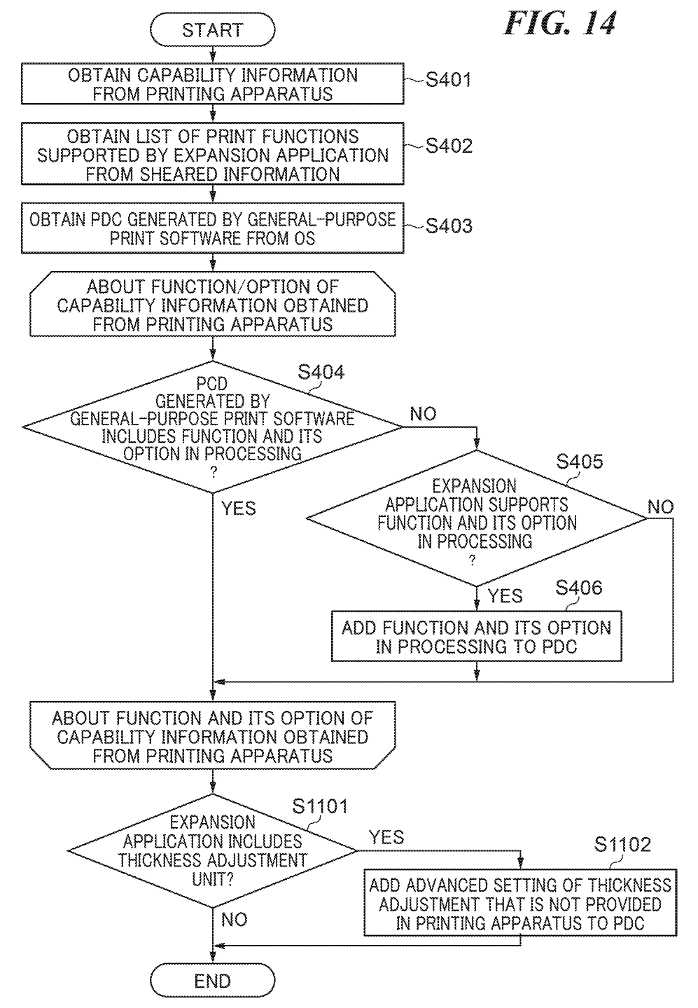

Hereinafter, a third embodiment will be described with reference to FIG. 14 to FIG. 19. Differences from the above-described embodiments will be mainly described, and description of the same matters will be omitted. In the second embodiment, when the printing apparatus 901 does not have the thickness adjustment function, the thickness adjustment unit 904 reflects the thickness adjustment to the intermediate data. On the other hand, when the printing apparatus 901 has the thickness adjustment function, the printing apparatus 901 can execute the thickness adjustment. There are various options of the thickness adjustment function, such as a thickness adjustment only for a line and a thickness adjustment only for a designated color. In the present embodiment, when an option of the thickness adjustment function that is executable by the printing apparatus 901 is designated, the printing apparatus 901 executes the designated option of the thickness adjustment function, and when an option of the thickness adjustment function that is not executable by the printing apparatus 901 is designated, the thickness adjustment unit 904 executes the designated option of the thickness adjustment function.

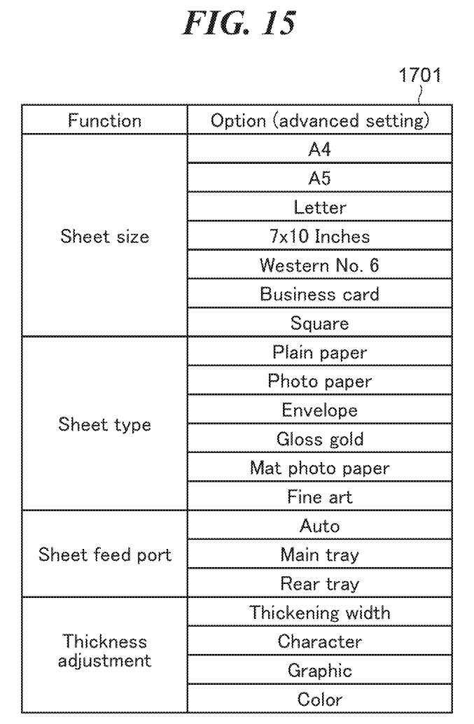

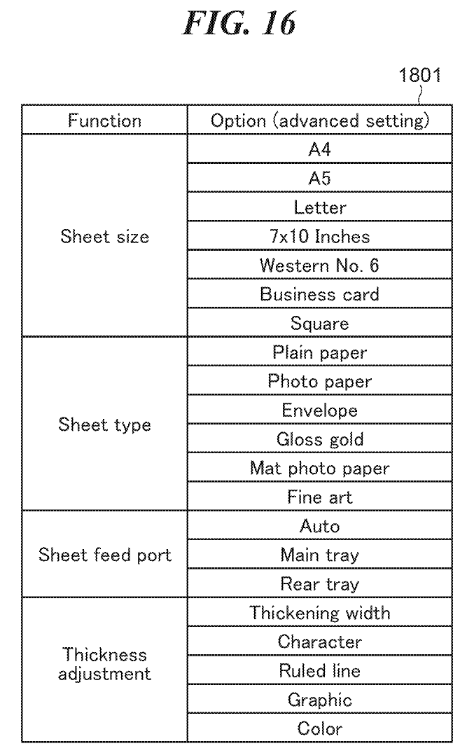

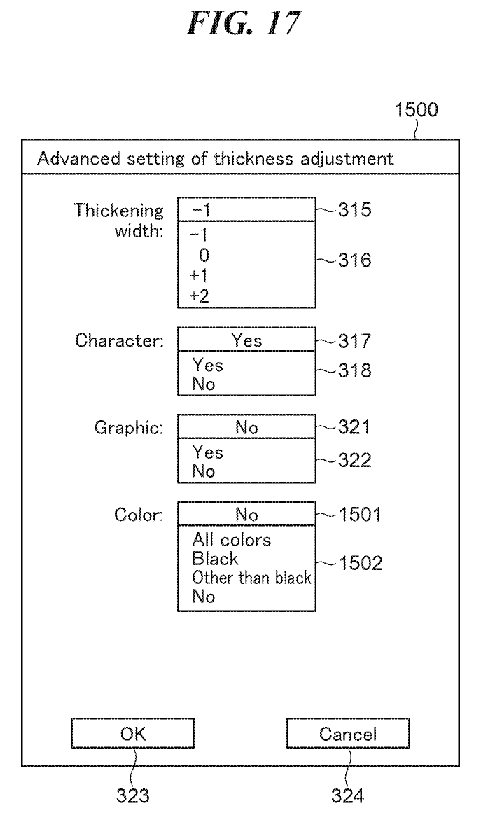

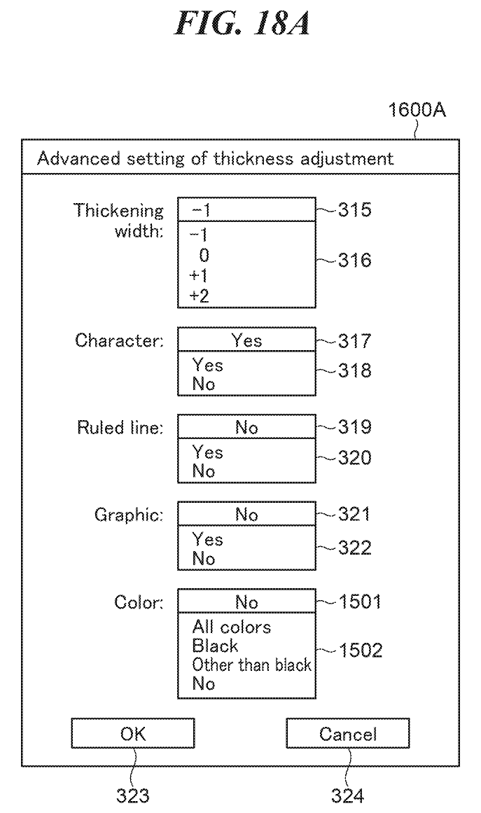

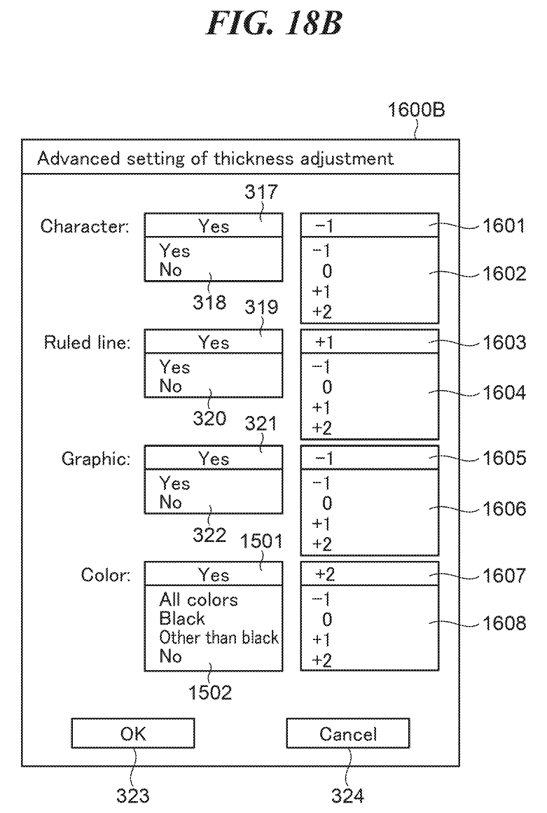

FIG. 14 is a flowchart illustrating a process in which the print function expansion unit related to the third embodiment edits the print function information. FIG. 15 is a view illustrating an example of a list of capability information of the printing apparatus. FIG. 16 is a view illustrating an example of a list of print functions supported by the expansion application. FIG. 17 to FIG. 18B are views illustrating examples of print setting screens displayed on a display unit of the print system. The thickness adjustment function in a table 1701 shown in FIG. 15 includes a thickness adjustment amount (thickening width), a character, a graphic, and a color as options. The thickness adjustment function in a table 1801 shown in FIG. 16 includes a thickness adjustment amount (thickening width), a character, a ruled line, a graphic, and a color as options. In the flowchart shown in FIG. 14, unlike the flowchart shown in FIG. 12, steps S1101 and S1102 are executed instead of the steps S1001 and S1002. When the repetitive process from the step S404 to the step S406 is completed, the thickness adjustment function capable of designating options including a character, a graphic, and a color is added to the print function information 203 because the printing apparatus 901 supports these options of the thickness adjustment function. The option “Ruled line” is not added to the print function information 203 among the options of the thickness adjustment function executable by the thickness adjustment unit 904.

As shown in FIG. 14, when the repetitive process from the step S404 to the step S406 is completed, the process proceeds to the step S1101. In the step S1101, the print function expansion unit 903 determines whether the thickness adjustment unit 904 is included in the expansion application 902. As a result of the determination in the step S1101, when it is determined that the thickness adjustment unit 904 is included, the process proceeds to the step S1102. On the other hand, as a result of the determination in the step S1101, when it is determined that the thickness adjustment unit 904 is not included, the process ends. As described above, since the expansion application 902 includes the thickness adjustment unit 904, the process proceeds to the step S1102.

In the step S1102, the print function expansion unit 903 add the information about the advanced setting of the thickness adjustment that is not included in the advanced setting of the thickness adjustment executable by the printing apparatus 901 and is executable by the thickness adjustment unit 904 to the print function information 203. Here, the option “Ruled line” in the table 1801 is added to the print function information 203. Accordingly, a displayed screen is changed to an advanced setting screen 1600A shown in FIG. 18A from an advanced setting screen 1500 shown in FIG. 17 after the control 312 on the advanced setting screen 300C is pressed. The advanced setting screen 1500 includes the controls 315, 317, 321, 323, and 324. In addition, the advanced setting screen 1500 includes a control 1501. The control 1501 is a color selector to select a choice of the option “Color” to be subjected to the thickness adjustment. When the control 1501 is pressed, a list 1502 including choices “All colors”, “Black”, and “Other than black” subjected to the thickness adjustment and “No” indicating that no color is designated as a target of the thickness adjustment are displayed. Then, a desired choice can be selected from “All colors”, “Black”, “Other than black”, and “No”. In FIG. 17, “No” is selected as an example. Unlike the advanced setting screen 1500, the control 319 is further added to the advanced setting screen 1600A. Further, as variation example of the advanced setting screen 1600A, an advanced setting screen 1600B shown in the FIG. 18B is exemplified. The advanced setting screen 1600B includes the controls 317, 319, 321, 323, 324, and 1501. The advanced setting screen 1600B includes controls 1601, 1603, 1605, and 1607.

The control 1601 is a thickness selector to select a set value that defines a thickness of a character. When the control 1601 is pressed, a list 1602 is displayed. The list 1602 includes “-1” for reducing the thickness of the character by one pixel, “0” for not changing the thickness of the character, “+1” for increasing the thickness of the character by one pixel, and “+2” for increasing the thickness of the character by two pixels. Then, a desired set value can be selected from among “-1”, “0”, “+1”, and “+2”. In FIG. 18B, “-1” is selected as an example.

The control 1603 is a thickness selector to select a set value that defines a thickness of a ruled line. When the control 1603 is pressed, a list 1604 is displayed. The list 1604 includes “-1” for reducing the thickness of the ruled line by one pixel, “0” for not changing the thickness of the ruled line, “+1” for increasing the thickness of the ruled line by one pixel, and “+2” for increasing the thickness of the ruled line by two pixels. Then, a desired set value can be selected from among “-1”, “0”, “+1”, and “+2”. In FIG. 18B, “+1” is selected as an example.

The control 1605 is a thickness selector to select a set value that defines a thickness of a graphic. When the control 1605 is pressed, a list 1606 is displayed. The list 1606 includes “-1” for reducing the thickness of the graphic by one pixel, “0” for not changing the thickness of the graphic, “+1” for increasing the thickness of the graphic by one pixel, and “+2” for increasing the thickness of the graphic by two pixels. Then, a desired set value can be selected from among “-1”, “0”, “+1”, and “+2”. In FIG. 18B, “-1” is selected as an example.

The control 1607 is a thickness selector to select a set value that defines a thickness of a line part having a color of the thickness adjustment target. When the control 1607 is pressed, a list 1608 is displayed. The list 1602 includes “-1” for reducing the thickness of the line part by one pixel, “0” for not changing the thickness of the line part, “+1” for increasing the thickness of the line part by one pixel, and “+2” for increasing the thickness of the line part by two pixels. Then, a desired set value can be selected from among “-1”, “0”, “+1”, and “+2”. In FIG. 18B, “+2” is selected as an example. In this manner, the thickness adjustment can be independently performed on the character, the ruled line, the graphic, and the line part having the color of the thickness adjustment target on the advanced setting screen 1600B.

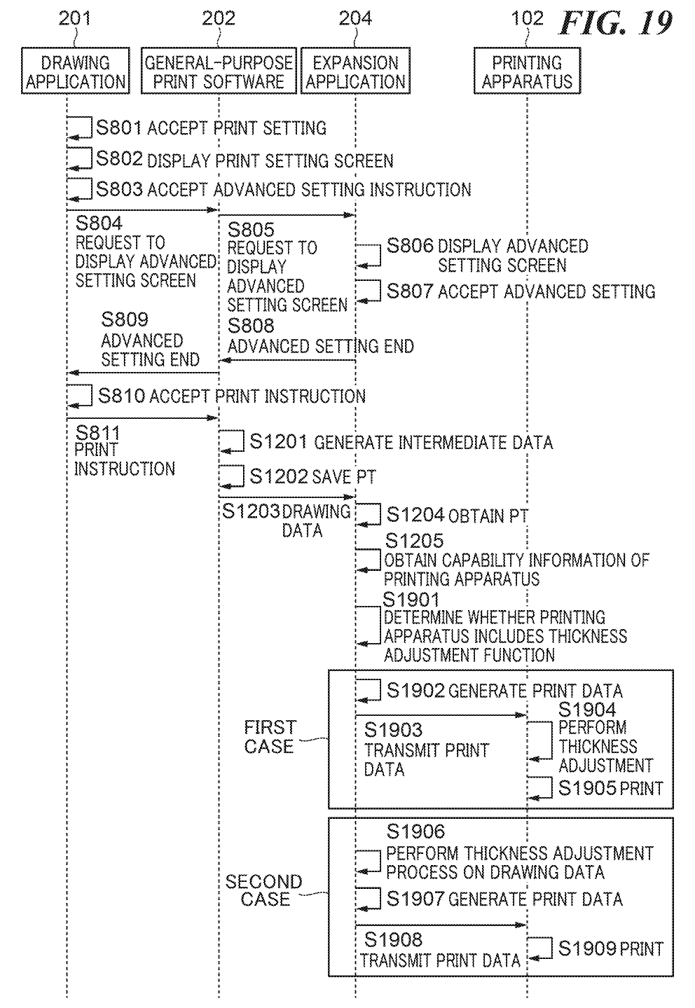

FIG. 19 is a sequence chart illustrating a process executed among the drawing application, the general-purpose print software, the expansion application, and the printing apparatus after the drawing application accepts a print setting. In the sequence chart shown in FIG. 19, unlike the sequence chart shown in FIG. 12, steps S1901 to S1909 are executed instead of the steps S1206 to S1210. In response to the reception of the advanced setting in the step S807, the sequence is divided into a first case in which the steps S1902 to S1905 are executed and a second case in which the steps S1906 to S1909 are executed.

First, a process in a case where an option “Character”, “Graphic”, or “Color” is selected in the advanced setting of the thickness adjustment will be described. As shown in FIG. 19, in the step S1901, the thickness adjustment unit 904 determines whether the printing apparatus 901 can process the advanced setting accepted in the step S807 on the basis of the capability information obtained in the step S1205. Here, when an option “Character”, “Graphic”, or “Color” is selected in the advanced setting, it is determined that the printing apparatus 901 can process, and the process proceeds to the step S1902.

In the step S1902, the intermediate data editing unit 207 generates printable print data using the print data and the print setting information.

In a step S1903, the intermediate data editing unit 207 transmits the print data generated In the step S1902 to the printing apparatus 901.

In the step S1904, the printing apparatus 901 interprets the print data transmitted in the step S1903 and performs a necessary image process (thickness adjustment process) on the print data.

In the step S1905, the printing apparatus 901 prints the print data subjected to the image process in the step S1904. As a result, the printing apparatus 901 outputs a printed matter of the print data in which the thickness adjustment is executed on any of the character, the graphic, and the color.

Next, a process in a case where an option “Ruled line” is selected in the advanced setting of the thickness adjustment will be described. In the step S1901, the thickness adjustment unit 904 determines whether the printing apparatus 901 can process the advanced setting accepted in the step S807 on the basis of the capability information obtained in the step S1205. Here, when the option “Ruled line” is selected in the advanced setting, it is determined that the printing apparatus 901 cannot process, and the process proceeds to the step S1906.

In the step S1906, the thickness adjustment unit 904 performs the thickness adjustment on the print data on the basis of the information related to the thickness adjustment setting obtained in the step S1204, and stores the print data subjected to the thickness adjustment in the shared information 208. The thickness adjustment unit 904 edits the set value of the thickness adjustment in the print setting information to “0” or deletes the setting of the thickness adjustment from the print setting information.

In the step S1907, the intermediate data editing unit 207 generates print data printable by the printing apparatus 901 using the print data subjected to the thickness adjustment that is stored in the shared information 208 and the print setting information.

In a step S1908, the intermediate data editing unit 207 transmits the print data generated In the step S1907 to the printing apparatus 901.

In the step S1909, the printing apparatus 901 interprets the print data transmitted in the step S1908, performs necessary image process on the print data, and then performs printing. As a result, the printing apparatus 901 outputs a printed matter of the print data in which the thickness adjustment is executed on any of the character, the graphic, and the color except for the ruled line.

As described above, the thickness adjustment setting includes two settings based on the thickness adjustment setting in the printing apparatus 901. The first setting enables execution of the thickness adjustment in the printing apparatus 901. The first setting includes the thickness adjustment for any of a character, a graphic, and a color. The second setting disables execution of the thickness adjustment in the printing apparatus 901. The second setting includes the thickness adjustment for a ruled line.

Then, when the thickness adjustment setting is the first setting, it is possible to instruct the printing apparatus 901 to execute printing based on the first setting (an instruction step). On the other hand, when the thickness adjustment setting is the second setting, the print data based on the second setting is generated (a generation control step), and then, the print data is transmitted to the printing apparatus 901, and thus, it is possible to instruct the execution of the printing (a transmission step). With such a configuration, it is possible to cause the printing apparatus 901 to execute printing in accordance with the type (option) of the thickness adjustment setting.

According to the present disclosure, it is possible to instruct the image forming apparatus to perform printing in which the thickness of the line constituting the image to be printed is adjusted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-201697, filed November 19, 2024 which is hereby incorporated by reference herein in its entirety.

What is claimed is:

1. A non-transitory computer-readable storage medium storing an application program causing a computer of an information processing apparatus to execute a control method comprising:
supporting a standard driver provided from a provider of an operating system of the information processing apparatus;
causing a display to display a setting reception screen on which a setting of a thickness adjustment to adjust a thickness of a line constituting an image to be printed is accepted; and
instructing an image forming apparatus to execute printing based on the setting of the thickness adjustment accepted on the setting reception screen.

2. The non-transitory computer-readable storage medium according to claim 1, wherein the setting reception screen includes a setting selector to select whether the setting of the thickness adjustment is enabled or disabled.

3. The non-transitory computer-readable storage medium according to claim 1, wherein the setting selection screen includes a thickness selector to select the thickness of the line as the setting of the thickness adjustment.

4. The non-transitory computer-readable storage medium according to claim 1, wherein an adjustment of a thickness of at least one of a character, a ruled line, and a graphic is possible on the setting reception screen as the thickness adjustment.

5. The non-transitory computer-readable storage medium according to claim 4, wherein the setting reception screen includes a setting selector to select whether the adjustment of the thickness of the at least one is enabled or disabled.

6. The non-transitory computer-readable storage medium according to claim 1, wherein the setting reception screen includes a forced restoration item to forcibly restore the setting of the thickness adjustment to an initial state.

7. The non-transitory computer-readable storage medium according to claim 1, wherein a function to accept the setting of the thickness adjustment cannot be executed by the standard driver.

8. A control method for an information processing apparatus, the control method comprising:
causing a display to display a setting reception screen on which a setting of a thickness adjustment to adjust a thickness of a line constituting an image to be printed is accepted by executing an application program that supports a standard driver provided from a provider of an operating system of the information processing apparatus; and
instructing an image forming apparatus to execute printing based on the setting of the thickness adjustment accepted on the setting reception screen by executing the application program.

9. An image processing apparatus comprising:
a display unit configured to display a setting reception screen on which a setting of a thickness adjustment to adjust a thickness of a line constituting an image to be printed is accepted by executing an application program that supports a standard driver provided from a provider of an operating system of the information processing apparatus; and
an instruction unit configured to instruct an image forming apparatus to execute printing based on the setting of the thickness adjustment accepted on the setting reception screen by executing the application program.
